(19) United States
(12) Patent Application Publication
(10) Pub. No.: US 2009/0060213 A1
(43) Pub. Date: Mar. 5, 2009

(54) Method for Determining the Position of a Moving Part in an Electroacoustic Transducer

(76) Inventors: Harry Bachmann, Staefa (CH); Daniel Schoeni, Meierskappel (CH); Alain Brenzikofer, Zuerich (CH); Norbert Felber, Zuerich (CH); Christian Schaffner, Jona (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/161,614

(22) PCT Filed: Jan. 18, 2007
(86) PCT No.: PCT/EP07/50509

§ 371 Date: Jul. 21, 2008

(30) Foreign Application Priority Data
Jan. 20, 2006 (CH) 0091/06

(51) Int. Cl. H04R 29/00

(52) U.S. Cl. 381/59

(57) ABSTRACT

Method and apparatus for determining a position and/or movement of a first part (1) relative to a second part in an electroacoustic transducer to which a signal for conversion is supplied. The method involves the first part (1) being irradiated with beams produced by a radiation source (12, 13), where the radiation source (12, 13) is rigidly connected to the second part, at least some of the beams produced by the radiation source (12, 13) being altered by the first part (1), at least some of the beams altered by the first part (1) being measured using a reception unit (14, 16), and the beams measured in the reception unit (14, 16) being taken as a basis for calculating the position and/or the movement of the first part (1) relative to the second part.

Firstly, the present invention relates to a method for determining a position and/or a motion of a first part in relation to a second part of an electro-acoustic converter, to which a signal to be converted is fed. Furthermore, a device according to the preamble of claim 8 is given.

Usually, electro-acoustic converters are used in the form of loudspeakers for reproducing music or other acoustic signals. Characteristic feature of loudspeakers is that the air pressure is changed corresponding to the signal to be reproduced. At the current constructions, this is managed with the aid of a surface, which has to be moved around a defined point, which in the following is referred to as diaphragm or diaphragm of a loudspeaker. At the current constructions, the motion of the diaphragm is controlled by the current flowing through a coil, the coil being mechanically connected to the diaphragm and usually moving in a magnetic field generated by a fixed magnet. However, the motion of the diaphragm can also be managed or controlled by a respective electric field being fed to the signal, respectively.

The underlying physical principle and its realization have an influence on a signal generated by a loudspeaker. This influence is undesirable, it insofar results from the motion of the diaphragm itself and is not to be attributed to the signal being fed to the converter. Reasons for the perturbing motions of the diaphragm are, on the one hand, a moment of inertia, which the diaphragm comprises due to its mass as well as the mass of the mechanically connected parts thereto, on the other hand, the influence of the motion of the diaphragm by the fastening, centering and guidance of the diaphragm.

Thus, characteristic features of a diaphragm of a loudspeaker are whose weight as well as whose stiffness.

Hence, the weight of the diaphragm is a characteristic feature, because the moment of inertia of the diaphragm changes with changing weight. This applies also to the components, which are connected to the diaphragm, and as a result thereof, are at least in part correspondingly moved components. The smaller the weight and therewith the moment of inertia of the diaphragm are, the more exact the course of the signal impinged on can be followed.

Therefore, the stiffness of the diaphragm must be referred to as characteristic feature, because a diaphragm with increasing stiffness is less deformed under the influence of the force acting upon it and accordingly, the air pressure is distributed on the whole surface of the diaphragm more evenly. Usually, the force acting upon the diaphragm is the signal to be reproduced or to be converted into a fluctuation of the air pressure, respectively, which is effected by a coil as a result of the signal fed to the coil, according to the method described beforehand. This is therefore worth mentioning, because usually the coil is only mechanically connected to one part of the diaphragm and the distribution of power acts unevenly upon it according to the stiffness of the diaphragm. Accordingly, the same principals apply also to converters underlying to a different physical principal, because also here, the deformation of the diaphragm represents a decisive factor and is also subject to comparable restrictions.

With respect to the characteristic features described beforehand, the underlying principle to the electro-acoustic converter plays only a minor role as long the change of air pressure is effected by a mechanical component, as a diaphragm for example.

Mainly, electro-acoustic converters can also then be characterized as qualitatively well, if they are in a position to reproduce the signal originally impinged on, true to original as much as possible or with distortions as less as possible, respectively. Thus, qualitatively well electro-acoustic converters are in a position to effect a change of the air pressure, which corresponds exactly to the signal originally fed to as much as possible.

There are already known different methods for surveying the motion of the diaphragm of the loudspeaker. However, depending on their form of realization the known converters have drawbacks. These are in the following described with concrete embodiments of realization.

In the US patent with the number U.S. Pat. No. 3,047,661 a method is described, by which the motion of a diaphragm of a loudspeaker is detected with the aid of a mechanical sensor appropriately placed in terms of a sensor. The drawbacks of this construction are obvious: The motion of the diaphragm is influenced by the mechanical sensor, whereby an additional error is added by the measurement. The mechanical sensor slows down the motion in the one direction of the motion of the diaphragm, in the other direction of the motion of the diaphragm, there is the risk that the sensor loses the contact to the diaphragm, because the sensor, due to its own weight, is also subject to a moment of inertia. Furthermore, this construction involves a not insubstantial effort.

Another method is described in the US patent with the number U.S. Pat. No. 4,727,584. In this patent, document the use of an acceleration sensor on the coil of the loudspeaker is described. This sensor increases the weight of the diaphragm, which in turn leads to an increase of the moment of inertia. In order to operate such a sensor, its connections must be provided with leads, which are mechanically loaded at each motion of the diaphragm of the loudspeaker and can break as a result of the material fatigue. Furthermore, a loudspeaker having an acceleration sensor makes the production more expensive, because additional components must be used and adjusted and additional wiring work is necessary.

The use of all kinds of sensors placed on the cone of the diaphragm, is described in the US patent with the number U.S. Pat. No. 3,821,473. Thereby, among other things, the use of piezoelectric and piezo-resistive sensors or the use of pressure sensitive colour as converter is described, which generate signals behaving proportional to the motion of the diaphragm of the loudspeaker. The mass moved also increases with this method. Furthermore, the production of the loudspeaker is relatively expensive. The wiring of the sensors can in addition—as described in the methods beforehand—break as a result of the material fatigue.

Other methods, for which a patent application has been made, provide the use of one or several additional coils being arranged on the cone of the diaphragm, concentrically around the diaphragm, which is moved by the coil. In this regard, it is representatively referred to the following publications: U.S. Pat. No. 4,243,839, U.S. Pat. No. 4,550,430 and U.S. Pat. No. 4,573,189. The known methods have the same drawbacks as they already have been described: The mass to be moved increases, an additional wiring becomes necessary and the production gets more expensive.

The use of Hall sensors, as it is described in JP-57184397, requires also an additional wiring. Furthermore, the mass to be moved is increased by the Hall sensor. Finally, the Hall sensor must be adjusted before applying in order to function reliably, which requires a certain additional effort.

Thus, the present invention has the object to provide a method eliminating the afore-mentioned drawbacks.

This object is solved by the measures given in claim 1. Advantageous embodiments as well as a device are given in further claims.

Firstly, the invention relates to a method for determining a position and/or motion of a first part in relation to a second part of an electro-acoustic converter, to which a signal to be converted is fed, the method consisting in
a first part being irradiated by rays generated by a radiation source, the radiation source being preferably rigidly connected to the second part,
at least one part of the rays generated by the radiation source is changed by the first part,
at least one part of the rays changed by the first part is measured with the aid of a receiver unit and
calculating the position and/or the motion of the first part in relation to the second part, due to the rays measured in the receiver unit.

In principal, the term “first part” of the present specification of the invention has to be understood as one or several movable components of the electro-acoustic converter, such as the diaphragm and the beads in particular. Further, the term “second part” of the present specification of the invention has to be understood as one or several solid components of the electro-acoustic converter, such as the chassis in particular.

The present invention makes the surveillance of the diaphragm possible, i.e. the first part of the electro-acoustic converter in order to carry out a correction at the signal to be converted, if need be, —i.e. at a motion of the diaphragm, which has not been caused directly by the signal to be converted. This invention makes it possible, to improve or to compensate one or several features of a loudspeaker described beforehand, respectively. Thus, the present invention allows to survey the motion of the diaphragm and to compare to the signal originally impinged on, whereby the moment of inertia can be compensated, effected by the curb weight and the weight of the components being connected to the diaphragm. Very often, the component effecting the motion of the diaphragm plays a decisive role for the current constructions of converters. This is then the case for example, if the electro-acoustic converter is based on an electro-magnetic principle and the motion is generated by a coil mechanically connected to the diaphragm for example.

An embodiment of the present invention is characterized in that a marking, arranged on the first part, is irradiated by the radiation source.

A further embodiment of the present invention is characterized in that the changes of the rays generated by the radiation source are caused either by a transfer via the first part or via a reflexion at the first part.

Yet, a further embodiment consists in that an intensity of the radiation is measured by the receiver unit.

Yet, a further embodiment consists in that the rays generated by the radiation source are bundled.

Yet, a further embodiment consists in that one of the following sources is used as radiation source:
electro-magnetic source with a radiation in the range of Terahertz;
source of laser;
source of light in the visible range;
source of light in the infrared range;
source of light in the ultraviolet range.

Finally, a further embodiment consists in that the measured position and/or the measured motion of the first part is compared to the signal to be converted for detecting an error signal, changing the signal fed to the electro-acoustic converter such that the error signal becomes minimal.

Furthermore, a device according to the present invention with an electro-acoustic converter is given, which comprises a first and a second part. The first part, displacable in relation to the second part, is characterized in that a radiation source, which generates rays, and a receiver unit are present, which are rigidly operatively connected to the second part, the radiation source being arranged in relation to first part in such way that at least one part of the rays of the radiation source reaches the first part and is changed by it, and the receiver unit being arranged in relation to the first part such that at least one part of the changed rays are received by the receiver unit.

An embodiment of the device according to the present invention is characterized in that a marking is arranged on the first part, the rays of the radiation source reaching at least one part of the marking.

Another embodiment of the device according to the present invention consists in that the radiation source and the receiver unit are arranged on the same side in relation to the first part.

A further embodiment of the device according to the present invention consists in that the radiation source and the receiver unit are arranged on the opposite side in relation to the first part.

Yet, a further embodiment of the device according to the present invention consists in that a radiation bundle unit is arranged between the radiation source and the first part.

Yet, a further embodiment of the device according to the present invention consists in that a radiation collection unit is arranged between the first part and the receiver unit.

Yet, a further embodiment of the device according to the present invention consists in that the radiation source is one of the following sources:
electro-magnetic source with a radiation in the range of Terahertz;
source of laser;
source of light in the visible range;
source of light in the infrared range;
source of light in the ultraviolet range.

Finally, a further embodiment of the device according to the present invention consists in that an amplifier and an addition unit are provided, to which a signal to be converted is impinged on a first input, the addition unit being operatively connected to the electro-acoustic converter and the output of the receiver unit being operatively connected to the second input of the addition unit.

In the following, the present invention is further described with examples of embodiments in reference to figures. There is shown:

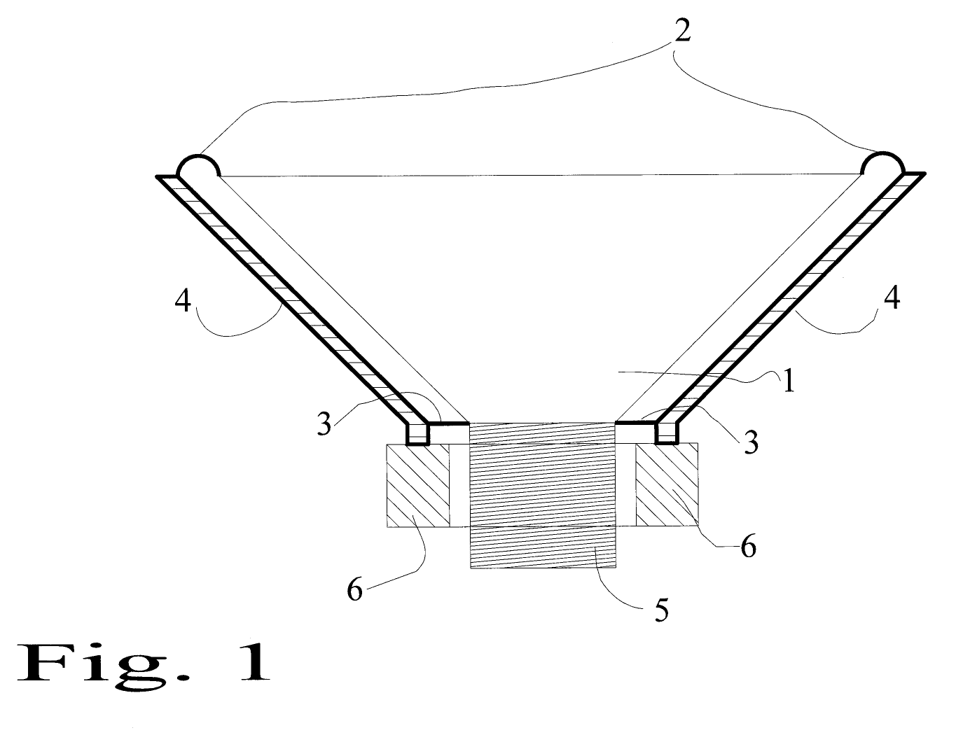

FIG. 1 a section through a known loudspeaker,

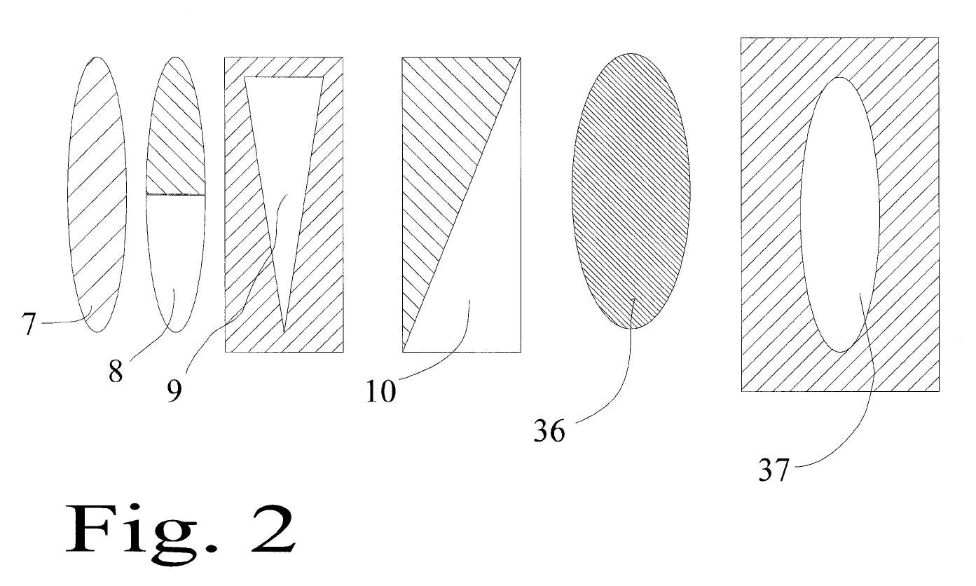

FIG. 2 different scope for designs for a marking on a loudspeaker according to the present invention,

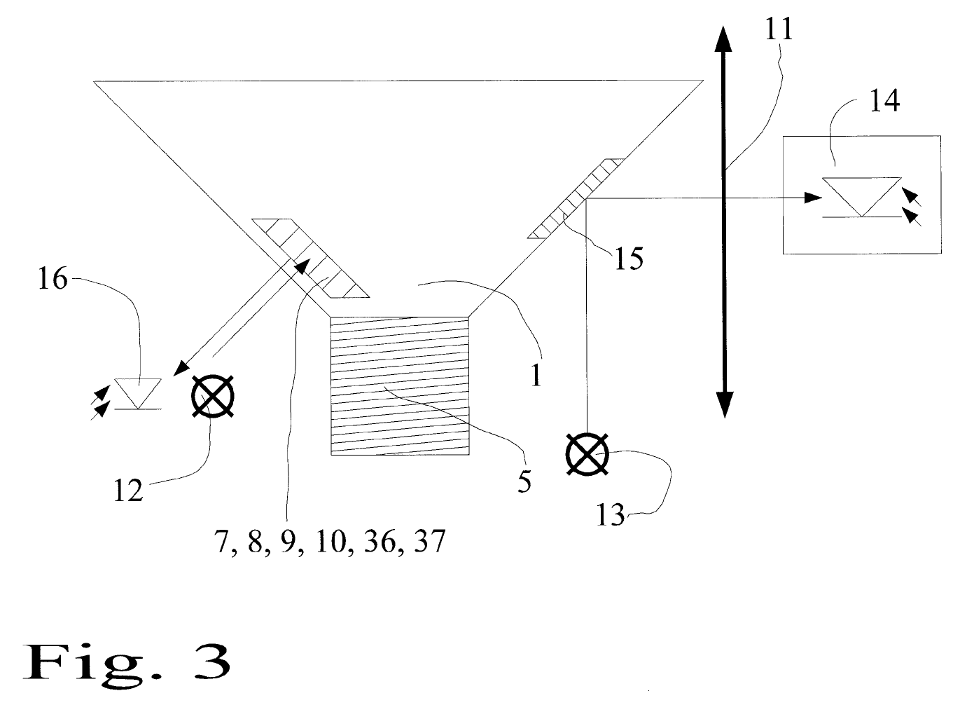

FIG. 3 a loudspeaker according to the present invention,

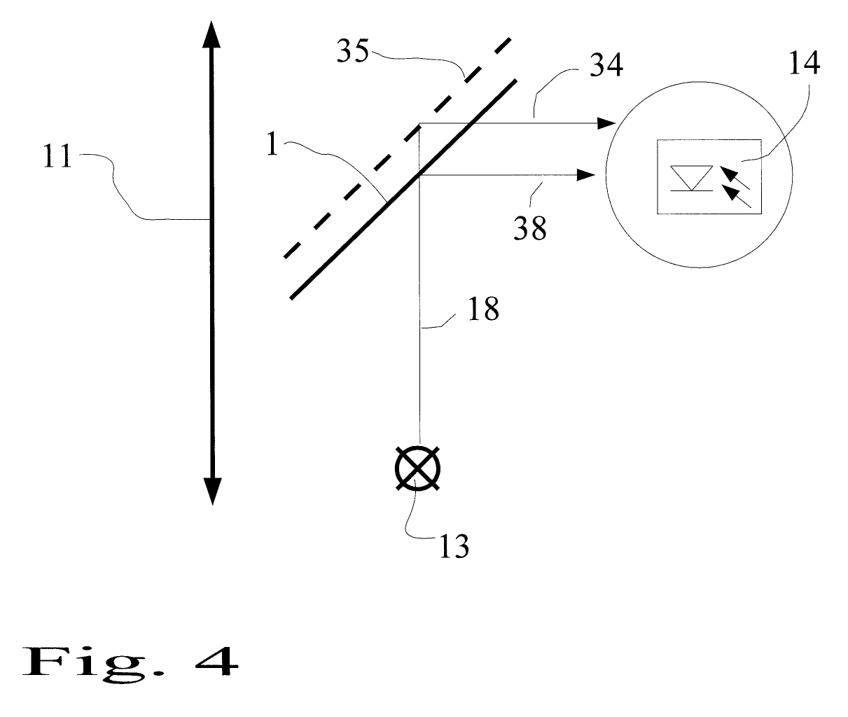

FIG. 4 a course of radiation for a loudspeaker according to the present invention,

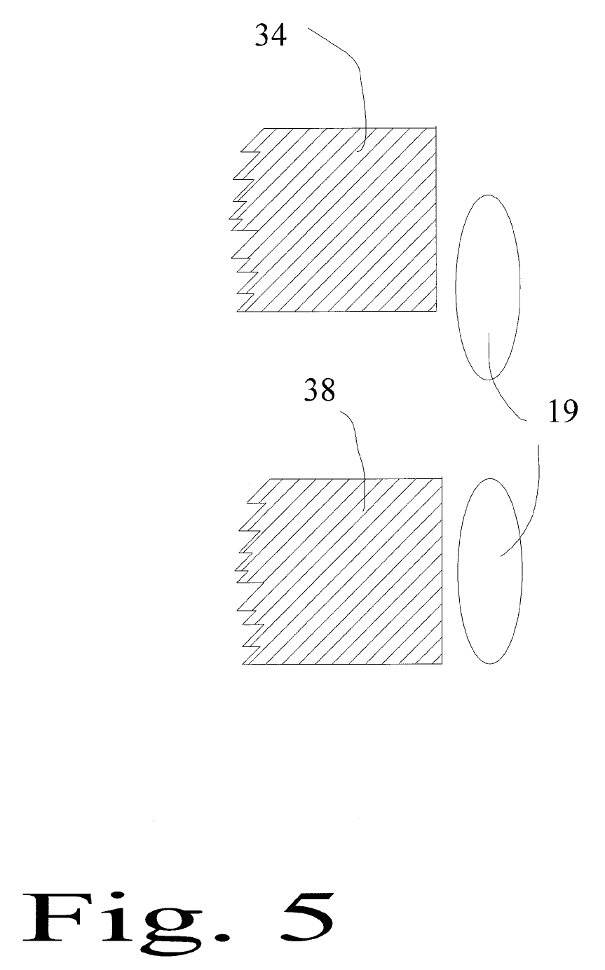

FIG. 5 a detailed depiction of the course of radiation according to FIG. 4,

FIG. 6 a further embodiment for a loudspeaker according to the present invention,

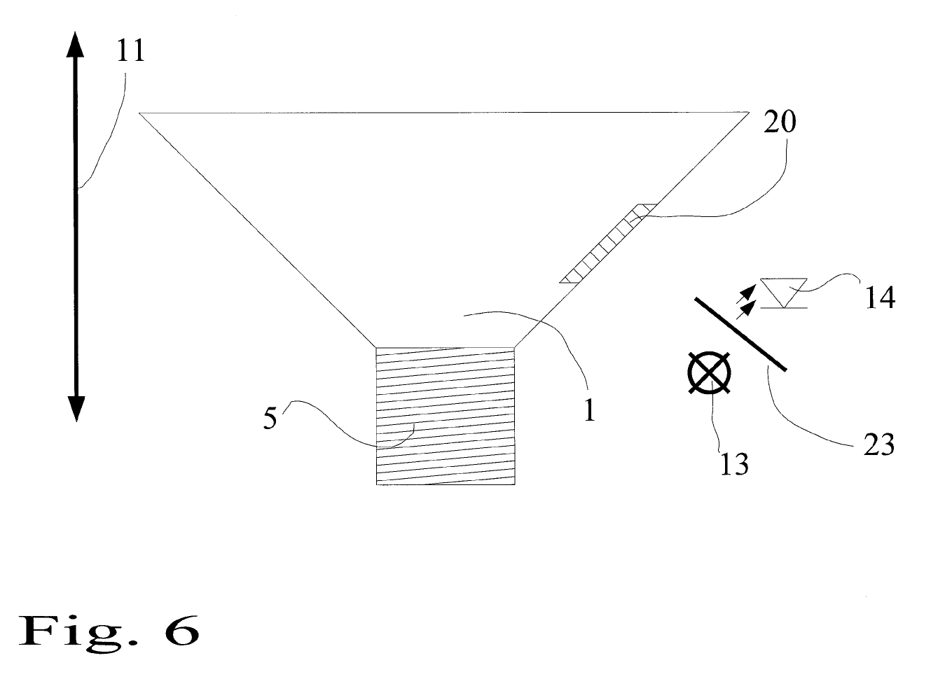

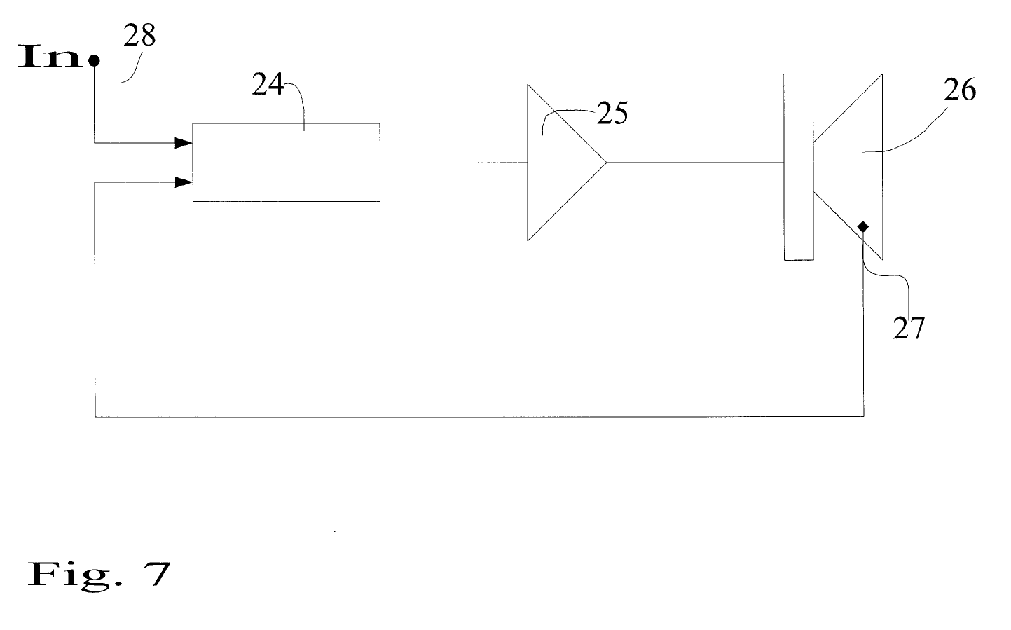

FIG. 7 a compensation circuit for compensating inaccuracies at a loudspeaker according to the present invention and

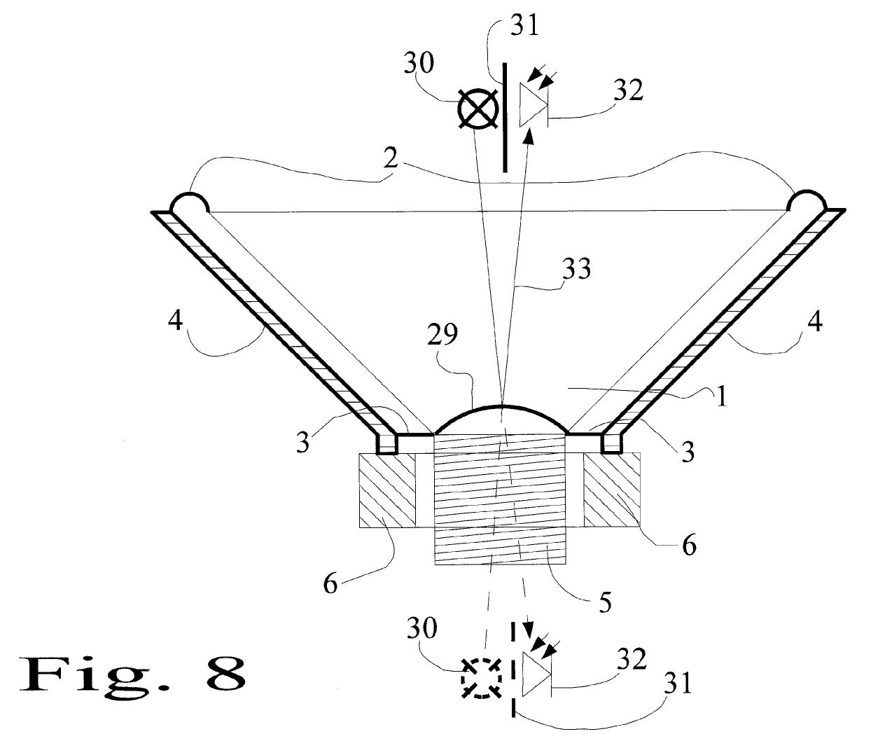

FIG. 8 a further embodiment for a loudspeaker according to the present invention.

In FIG. 1, a section of an actually known loudspeaker is depicted. With this section the basic set of problems encountered while controlling loudspeakers shall once again be illustrated. Only those parts of the loudspeaker are depicted in FIG. 1, which have to be illustrated in connection to the invention.

1 characterizes a diaphragm, which is driven by a coil 5 and is conducted by a bead 2 as well as by a centering 3. Together, the bead 2 and the centering 3 define a point of rest of the diaphragm 1. The diaphragm engages the point of rest if the coil is current less, i.e. if no signal is fed to the converter. The bead 2 and the centering 3 are mounted on a chassis 4 being connected to a permanent magnet 6. As soon as a current flows through the coil 5 a magnetic field generated by the current acts upon a force on the diaphragm 1. Now, if the direction of the current changes in the coil 5, the direction of the motion of the diaphragm 1 is also changed correspondingly. Due to the inertia of the diaphragm 1, however, the reversal-motion is timely delayed, i.e. the motion of the diaphragm 1 will not correspond to the signal impinged on the coil 5 during a short time. As the coil 5 is mechanically connected to the diaphragm 1 and hence, the mass to be moved is increased, the moment of inertia of the whole construction will additionally be amplified.

The present invention consists in to give a method for surveying the motion of a mechanical component, as a diaphragm of a loudspeaker for example, as well as a method for correcting the motion of the mechanical component in order to optimize the reproduction of the mechanical component of the signal impinged on. The mechanical component can be understood as part of an electro-acoustic converter having the duty to effect a change of the air pressure corresponding to the signal fed to originally, whereby this method can also be used for other converter systems, by which the mechanical inertia of a moved component influences the quality of conversion.

Thereby, the motion of the mechanical component is surveyed contact-free and with the aid of a suitable control loop the signal fed to the converter is changed such that the motion of the mechanical component corresponds to the signal originally fed to the converter.

The determination of the acceleration of a moved component, respectively the change of the acceleration of a moved component can also be obtained with the aid of a repeated determination of the position and the subsequent comparison of the respective positions determined of the moved component in consideration of the time elapsed between determining the respective position. For this reason, statements in relation to the determination of a position are applicable to the determination of the acceleration or velocity, respectively.

In the following, several possibilities for realizing the invention shall be described. Hereto, the method is looked at from different aspects.

On the one hand, the position of the mechanical component must be determined reliably—without influence it, on the other hand, the difference to the signal fed to originally must be determined and the error determined must be impinged on the signal fed to, in order to correct the position of the mechanical component such that the position corresponds to the signal originally fed to.

In the following, methods for the determination of the position of the mechanical component according to the invention presented here are described firstly, which are not subject to the impairments described in the beginning.

In order to survey the motion of the diaphragm, respectively to determine its position, the motion can be surveyed with the aid of a light projecting method with the aid of a marking 7, 8, 9, 10, 36 and 37 mounted on the outside of the diaphragm (FIG. 1) and accordingly shaped (FIG. 2). Besides the marking 7, 8, 9, 10, 36 and 37, depicted in FIG. 2, also conic sections are usable for example, whereas a plurality of further scopes of design for the marking 7, 8, 9, 10, 36 and 37 or the conic sections are obviously conceivable, respectively.

In FIG. 3, a loudspeaker according to the present invention is depicted as a section analogous to the known loudspeaker showed in FIG. 1. One or several of the markings 7, 8, 9, 10, 36 and 37, as they are depicted in FIG. 2 for example, are arranged on the diaphragm 1. The marking 7, 8, 9, 10, 36 and 37 is irradiated by the light source 12, whereon it, according to its design, the light reflects dependent on the position of the diaphragm 1. The light reflected is converted by a light-sensitive receiver unit 16 into a respective electric signal, which is fed to a continuing processing unit (not depicted). If the diaphragm 1 moves according to an indication of the direction 11, the marking 7, 8, 9, 10, 36, 37 dislocates together with the diaphragm 1. This effects that the light emitted by the light source 12 is differently strong reflected and accordingly, the light-sensitive receiver unit 16 measures a smaller brightness. The position of the diaphragm 1 can be determined with the brightness measured by the receiver unit 16.

A further possibility for determining the position of the diaphragm 1 is also depicted in FIG. 3 according to the invention presented here. It is explicitly pointed out that—although showed for the same loudspeaker in FIG. 3—the further possibility for determining the position is independent from the possibility already described. Accordingly, the one or the other possibility can be used, not excluding a simultaneous use of both possibilities. This is in particular then conceivable, if the functionality or the accuracy of the position has to be surveyed.

For the following further possibility for determining the position, a smooth, reflective surface 15 is provided in direction of the motion 11 of the diaphragm 1, which is irradiated by a further light source 13, a laser light source for example, also other rays being used instead of laser light or standard light in the visible range, light in the range of infrared for example, in the range of ultraviolet or in the range of Terahertz. This radiation is reflected by the surface 15. The ray emitted by the further light source 13 moves synchronically with the diaphragm 1 at a motion of the diaphragm 1 according to the indications of the direction 11 after being reflected by the surface 15. This motion is detected by a further receiver unit 14, which is a photo resistor, a photo diode, a photo transistor or other suitable means.

A further possibility to detect the acceleration with reflective radiation shall also be exemplified by FIG. 3 and the further light source 13, the further receiver unit 14 and the surface 15. The surface 15 is also formed smoothly in direction of the motion 11 of the diaphragm 1. The surface 15 reflects the respective used radiation, which is emitted by the further light source 13. Here, it is also a precondition that the radiation is bundled. In the optimum case, the diameter of the ray corresponds to the diameter of the further receiver unit 14, whereas this condition must not mandatory be full filled. It is crucial that the ray reaches the further receiver unit 14 such that a motion of the diaphragm 1 can be detected in the further receiver unit 14 in the preset direction of the motion 11, which can be achieved through a change of the intensity of the incident light or the incident radiation, respectively. This is clarified in FIG. 4 and FIG. 5, FIG. 5 being a detailed depiction of the encircled area in FIG. 4. A cutting of the diaphragm 1 is depicted in FIG. 4, which is irradiated with a light ray 18 of a light source 13. The receiver unit 14 receives the ray 38 reflected by the diaphragm 1. If the diaphragm 1 moves in direction of the motion 11, the ray 18 emitted by the light source 13 strikes on another place of the diaphragm 1. In FIG. 4, this is clarified with a second position 35 of the diaphragm 1 in dashed lines, which leads to a reflective ray 34 instead of the ray 38 reflected. A change of the brightness arises at the receiver unit 14 in consequence of a deflection of the diaphragm 1 in direction of the motion 11, as being apparent in FIG. 5, FIG. 5 depicting the optimum case, as the reflected ray 38 falls centrally to a receiver surface 19 of the receiver unit 14.

In FIG. 5 is depicted, how the reflected ray 38 enters to the receiver surface 19 at the maximum deflection of the diaphragm 1 in direction of the motion 11. In this case, the relevant receiver surface 19 is completely covered by a light ray 38, which corresponds to a maximum intensity. If the diaphragm 1 changes its position, respectively its acceleration—also if it gets moved—the resulting intensity is smaller on the receiver surface 19 by the ray 34 reflected. Therewith, the motion or the position, respectively, of the diaphragm can be derived, i.e. determined, from the intensity measured of the rays 34, 38 reflected.

In principle, determining the acceleration of the diaphragm 1 is realizable with the aid of a so called measurement of light-through measurement, this method assuming a known thickness of the diaphragm 1 on the place relevant. Hereto, the diaphragm 1 is irradiated from one side by an electro-magnetic wave having a relative long wavelength, the place of diaphragm 1 to be irradiated being formed such that the permeability of the diaphragm 1 in- or decreases constantly on the relevant place of the diaphragm 1 in the direction of the motion 11. The existing residual radiation can be determined with the aid of a suitable sensor on the other side of the diaphragm 1. For this kind for determining the position, radiation in the range of Terahertz is suitable, whereas also X-rays could principally be used. This kind for determining the position would also work for radio waves, the efficiency being smaller in comparison to a radiation in the Terahertz range, because the radio waves can be bundled less well. In principal, each kind of electromagnetic radiation can be used for this kind of determining the position, as long as it is capable to penetrate the diaphragm 1 at the relevant place, whereas it has to be mentioned that the efficiency of the measurement is dependent on the degree of bundling of the radiation used.

Independent of the way of determining the position, starting from the signal in the receiver unit 14 with the aid of a suitable control loop, the signal to be fed to the electro-acoustic converter is corrected such that the resulting motion of the diaphragm 1 corresponds to the signal originally fed to the electro-acoustic converter. Therewith, the inaccuracies, caused by the diaphragm itself, are eliminated.

In FIG. 6 it is depicted, how the present invention can also be realized. Hereto, a constant reflecting element 20 is applied on one side of the diaphragm 1. This can be of a definite shape with a certain colour for example. The use of a sticker is conceivable for example, a painted on or printed shape or an alternative method. According to FIGS. 2, 36 and 37 show possible embodiments of this reflecting surface, whereas other shapes can definitely be used. The shape influences the linearity of the change of the intensity measured by the receiver unit 14.

In this case, reflecting means that the reflecting element 20 mounted on the diaphragm 1 has another coefficient of absorption than the residual surface of the diaphragm 1, whereas it is advantageous if the coefficient of absorption is evenly inside of the reflecting element 20. 13 in turn is a radiation source, which among others irradiates the reflecting element 20, and 14 in turn characterizes a receiver unit, which receives the radiation reflected by the diaphragm 1. The distance of the reflecting element 20 changes in relation to the receiver unit 14, if the diaphragm 1 moves in direction of the motion 11. This has as a consequence that the intensity of radiation received by the receiver unit 14 is changed, and, in fact, in direct dependence on the distance of the diaphragm 1 to the receiver unit 14. In order to prevent a direct irradiation of the light source 13 to the receiver unit 14, a separation element 23 is provided. In optimizing the shape of the reflecting element 20, the change of the intensity of radiation received by the receiver unit 14 can be influenced such that a linear relation between the shifting and the measured intensity of radiation arises. The use of a reference receiver for compensating possible existing influences of external radiation is also provided in a further embodiment.

A further embodiment of the present invention based on an alternative principle, shall be depicted in FIG. 8. Here, a spherical cap 29 of the loudspeaker is bombarded by a ray 33 of a source 30. The ray 33 is characterized in that it comprises a signal modulated on the ray 33. The spherical cap 29 is best suitable for the use according to this method described subsequently, because with this spherical cap 29, it is about of that part, which shows the greatest stiffness of the parts, which shall effect a fluctuation of the air pressure at an electro-acoustic converter. However, this is not a mandatory requirement for the present embodiment. The signal modulated on the ray effects that, in case of the different distance between the source 30 and the spherical cap 29, respectively between the spherical cap 29 and the receiver unit 32, the difference for the running time effected by the changing distance can be used for determining the acceleration of the diaphragm 1. The difference of the running time can precisely be determined by the signal modulated on the ray 33, whereas this method can be refined by the signal modulated on the ray 33 shows no regular characteristic.

A further embodiment of this method consists in determining the change of the frequency of the signal modulated on the ray 33, resulting from the motion of the diaphragm 1, out of which the acceleration can be derived from.

As far as the permanent magnet 6, usually used for electro-acoustic converters, has a hole in the centre, as it is often present because of the better cooling, this method can also be used on the side of the spherical cap 29 between the spherical cap 29 and the permanent magnet 6, according to the depiction in dashed lines.

The advantage of the methods described beforehand, consists in that no additional wiring on or to the moved parts is necessary and the moved mass is practically not increased. The weight of the reflectors or markings 7, 8, 9, 10, 36, 37, respectively, to be applied are in comparison to the mass of the diaphragm 1 small enough, so that the motion of the diaphragm 1 is not affected thereby.

The invention presented here, has a direct influence on the quality of the reproduced signal. Because the motion of the diaphragm 1 is corrected such in direction of the indication 11 that it corresponds to the signal originally fed to the converter, distortions are minimized. Furthermore, the latency is reduced. An extension of the useable frequency range is as well possible for the converter. The volume necessary for the provided object can be reduced, because the motion of the diaphragm 1 can directly be optimized at low frequencies; the useable frequency range can be corrected towards higher as well as lower frequencies. The linearity of the phase of the diaphragm 1 in relation to the signal originally fed to the converter can be improved by the invention presented here.

A further use according to the invention is the protection from overload of the electro-acoustic converter. As, according to the method of the invention, position, acceleration and motion of the movable component of an electro-acoustic converter can be determined, and the values determined according to the invention can be compared to a signal fed to the converter or to a signal, which has to be fed to the converter after a corresponding processing, the possibility is given to avoid excessive values, which can lead to a damage or an impairment of the movable component of the electro-acoustic converter by limiting the signal to be fed to the converter correspondingly. The diaphragm 1 is hold in position by the bead 2 and the centering diaphragm 3. Those parts can be destroyed if the deflection of the diaphragm 1 exceeds a certain measure, thus, the reason to the afore-described impairment or damage of the diaphragm 1 is mechanically. The coil 5 can also be damaged at too great deflection of the diaphragm 1, namely then, when the coil 5 mechanically contacts another part of the electro-acoustic converter. This can be—but must not be—depending on the construction the permanent magnet 6 or the chassis 4.

As far as the inaccuracies of an electro-acoustic converter in relation to a signal to be reproduced are known, the compensation of these errors are possible with the circuit for example, described in FIG. 7. The circuit consists of an addition unit 24, an amplifier 25, a loudspeaker 26 and a sensor element 27 for measuring the position of the diaphragm or the acceleration of the diaphragm, respectively. A signal to be reproduced is impinged on the connection 28 of the addition unit 24, whose output signal is connected via the amplifier 25 to the electro-acoustic converter 26. The acceleration of the diaphragm is measured by the sensor element 27, whose electrical value is fed to a further input of the addition unit 24 in order to compensate the signal 28 to be reproduced originally such that the acceleration measured at 27 corresponds to the signal 28 originally fed to.

1. Method for determining a position and/or motion of a first part (1) in relation to a second part (4) of an electro-acoustic converter (26), to which a signal (In) to be converted is fed, the method comprising:
irradiating the first part (1) by rays (18) generated by a radiation source (12, 13), the radiation source (12, 13) being rigidly connected to the second part (4),
changing at least one part of the rays (18) generated by the radiation source (12, 13) by the first part (1),
measuring at least one part of the rays (18) changed by the first part (1) with the aid of a receiver unit (14, 16), and
calculating the position and/or the motion of the first part (1) in relation to the second part (4) as a result of the rays (18) measured in the receiver unit (14, 16).

2. Method according to claim 1, wherein a marking (7, 8, 9, 10, 36, 37), arranged on the first part (1), is irradiated by the radiation source (12, 13).

3. Method according to claim 1, wherein the changes caused by the first part (1) of the rays (18) generated by the radiation source (12, 13) arise either by a transfer via the first part (1) or via a reflection the first part (1).

4. Method according to claim 1, wherein intensity of the radiation is measured by the receiver unit (14, 16).

5. Method according to claim 1, wherein the rays (18) generated by the radiation source (12, 13) are bundled.

6. Method according to claim 1, wherein the radiation source (12, 13) is selected from the group consisting of:
electro-magnetic source with a radiation in the range of Terahertz;
laser source;
light source with light in the visual range;
light source in the infrared range;
light source in the ultraviolet range.

7. Method according to claim 1, wherein the measured position and/or the measured motion of the first part (1) is compared to the signal (ln) to be converted for determining an error signal that, on the basis on the error signal, the signal fed to the electro-acoustic converter (26) is changed such that the error signal becomes minimal.

8. Device with an electro-acoustic converter (26), which comprises a first part (1) and a second part (4), the first part (1) being displacable in relation to the second part (4), wherein a radiation source (12, 13) generating rays (1) and a receiver unit (14, 16) are present, which are rigidly operatively connected to the second part (4), the radiation source (12, 13) being arranged in relation to the first part (1) such that at least one part of the rays (18) of the radiation source (12, 13) reaches the first part (1) and is changed by the first part, and the receiver unit (14, 16) being arranged in relation to the first part (1) such that at least one part of the changed rays (18) is received by the receiver unit (14, 16).

9. Device according to claim 8, wherein a marking (7, 8, 9, 10, 36, 37) is arranged on the first part (1), at least one part of the rays (18) of the radiation source (12, 13) reaching the marking (7, 8, 9, 10, 36, 37).

10. Device according to claim 8 wherein the radiation source (12, 13) and the receiver unit (14, 16) are arranged on the same side in relation to the first part (1).

11. Device according to claim 8, wherein the radiation source (12, 13) and the receiver unit (14, 16) are arranged on opposite sides in relation to the first part (1).

12. Device according to claim 8, including a radiation bundle unit arranged between the radiation source (12, 13) and the first part (1).

13. Device according to claim 8, including a radiation bundle unit arranged between the first part (1) and the receiver unit (14, 16).

14. Device according to claim 8, wherein the radiation source (12, 13) is selected from the group consisting of:
electro-magnetic source with a radiation in the Terahertz range;
laser source;
light source with light in the visible range;
light source in the infrared range;
light source in the ultraviolet range.

15. Device according to claim 8, wherein an amplifier (25) and an addition unit (24) are provided, to which a signal (ln) to be converted is impinged on a first input, the addition unit (24) being operatively connected to the electro-acoustic converter (26) via the amplifier (25) and an output of the receiver unit (14, 16) being operatively connected to a second input of the addition unit (24).
